(19) United States
(12) Patent Application Publication
(10) Pub. No.: US 2013/0177752 A1
(43) Pub. Date: Jul. 11, 2013

(54) CONDUCTIVE FILM AND CONDUCTIVE FILM ROLL

(71) Applicant: NITTO DENKO CORPORATION, Osaka (JP)

(72) Inventors: Nozomi Fujino, Ibaraki (JP); Hiroyuki Takao, Ibaraki (JP); Kuniaki Ishibashi, Ibaraki (JP)

(73) Assignee: NITTO DENKO CORPORATION, Osaka (JP)

(21) Appl. No.: 13/734,533

(22) Filed: Jan. 4, 2013

(30) Foreign Application Priority Data
Jan. 5, 2012 (JP) 2012-000736

(51) Int. Cl. H01B 5/14

(52) U.S. Cl. CPC H01B 5/14
USPC 428/216; 428/336

(57) ABSTRACT

A conductive film includes a film base, a first transparent conductor layer formed on one side of the film base, a first copper layer formed on a side of the first transparent conductor layer opposite to the film base, a second transparent conductor layer formed on the other side of the film base, a second copper layer formed on a side of the second transparent conductor layer opposite to the film base, and a first oxide membrane layer formed on a side of the first copper layer opposite to the first transparent conductor layer, the first oxide membrane layer containing copper (I) oxide and having a thickness of 1 nm to 15 nm.

### CROSS REFERENCE TO RELATED APPLICATIONS

This application claims the benefit of Japanese Application No. 2012-000736, filed Jan. 5, 2012, which is hereby incorporated by reference herein in its entirety.

### BACKGROUND OF INVENTION

1. Field of the Invention

The invention relates to a conductive film applicable to an input display unit capable of inputting information by a touch of a finger, a stylus pen, or the like, and a conductive film roll.

2. Background of the Invention

In the related art, a conductive film including a transparent conductor layer formed on each surface of a film base and a metal layer formed on a surface of each transparent conductor layer is known (Japanese Laid-Open Patent Publication No. 2011-060146). When employing such a conductive film for a touch sensor, for example, a narrow bezel can be achieved by processing a metal layer and forming a wiring at an outer peripheral portion of a touch input area.

However, with such a conductive film of the related art, when the film is wound up in a roll, there is a problem that adjacent film surfaces could be bonded to each other. When the bonded film surfaces are peeled apart, flaws may be produced in the transparent conductor layer in the film and may cause degradation in the quality.

### SUMMARY OF INVENTION

It is an object of the invention to provide a conductive film and a conductive film roll in which, when the conductive film is wound up in a roll, the adjacent film surfaces will not be bond to each other and a high quality can be maintained.

To achieve the above mentioned object, in an aspect of the invention, a conductive film includes a film base, a first transparent conductor layer formed on one side of the film base, a first copper layer formed on a side of the first transparent conductor layer opposite to the film base, a second transparent conductor layer formed on another side of the film base, a second copper layer formed on a side of the second transparent conductor layer opposite to the film base, and a first oxide membrane layer formed on a side of the first copper layer opposite to the first transparent conductor layer, the first oxide membrane layer containing copper (I) oxide and having a thickness of 1 nm to 15 nm.

Preferably, the first oxide membrane layer has a thickness of 1.0 nm to 8.0 nm.

Also, preferably, the first oxide membrane layer is made of a composition including greater than or equal to 50% by weight of copper (I) oxide and including copper, copper (II) oxide, copper carbonate and copper hydroxide. More preferably, the first oxide membrane layer substantially consists of copper (I) oxide. The conductive film preferably further includes a second oxide membrane layer formed on a second copper layer, the second oxide membrane layer containing copper (I) oxide and having a thickness of 1 nm to 15 nm.

Also, in order to achieve the above object, a conductive film roll of an aspect of the invention is constituted by the conductive film that is wound up in a rolled shape.

According to the invention, the first oxide membrane layer is formed on a side of the first copper layer opposite to the first transparent conductor layer. Consequently, when the conductive film of the invention is wound up in a roll, since the first oxide membrane layer is interposed between the first copper layer and second copper layer, it is possible to suppress metallic bonding between the first copper layer and second copper layer. Also, with the thickness of the first oxide membrane layer containing copper (I) oxide being 1 nm to 15 nm, since adjacent film surfaces are bonded to each other, no flaw is produced in the first transparent conductor layer and a high quality can be maintained.

Also, since the first oxide membrane layer has a thickness of 1.0 nm to 8.0 nm, the adjacent film surfaces can be positively prevented from being bonded to each other.

Further, since the first oxide membrane layer is made of a composition including greater than or equal to 50% by weight copper (I) oxide and including copper, copper (II) oxide, copper carbonate and copper hydroxide, the adjacent film surfaces can be positively prevented from being bonded to each other.

Further features of the invention will become apparent from the following detailed description of exemplary embodiments with reference to the attached drawings.

### BRIEF DESCRIPTION OF DRAWINGS

FIG. 1 is a perspective view schematically showing a configuration of a conductive film roll in which a conductive film of an embodiment of the invention is wound up.

FIG. 2 is a partially enlarged view of a variant embodiment of the conductive film of FIG. 1.

FIG. 3 is a perspective view illustrating a variant embodiment of the conductive film roll of FIG. 1.

### DETAILED DESCRIPTION

Hereinafter, an embodiment of the invention will be described in detail with reference to the accompanying drawings.

FIG. 1 is a perspective view schematically showing a configuration of a conductive film roll in which a conductive film of the present embodiment is wound up. Note that, the thickness of each layer in FIG. 1 is shown by way of example, and the thickness of each layer of the conductive film of the invention is not limited the thickness shown in FIG. 1.

As shown in FIG. 1, a conductive film 1 of the invention includes a film base 2, a transparent conductor layer (first transparent conductor layer) 3 formed on one side of the film base, a copper layer (first copper layer) 4 formed on a side of the transparent conductor layer 3 opposite to the film base 2, a transparent conductor layer (second transparent conductor layer) 5 formed on the other side of the film base 2, a copper layer (second copper layer) 6 formed on a side of the transparent conductor layer 5 opposite to the film base 2, and an oxide membrane layer (first oxide membrane layer) 7 formed on a side of the copper layer 4 opposite to the transparent conductor layer 3, the oxide membrane layer 7 containing copper (I) oxide and having a thickness of 1 nm to 15 nm.

A conductive film roll 8 is constituted by the conductive film 1 having an elongated shape wound up into a rolled shape. The conductive film 1 has a length of, e.g. greater than or equal to 100 m, and preferably 500 m to 5,000 m. Generally, a winding core 9 made of plastic or metal for winding the conductive film 1 thereon is placed at a center portion of the conductive film roll 8.

With such a conductive film roll, since the oxide membrane layer 7 having a thickness of 1 nm to 15 nm and containing copper (I) oxide is formed on a side of the copper layer 4 opposite to the transparent conductor layer 3, there is an advantageous effect that bonding between the conductive film surfaces does not occur even if a slip sheet is not inserted between the conductive film surfaces when winding. This can be presumed to be because, when the conductive film is wound up in a roll, the oxide membrane layer 7 containing copper (I) oxide without free electron is interposed between the copper layer 4 and the copper layer 6 which are adjacent to each other, and thus metallic bonding between the copper layer 4 and the copper layer 6 can be prevented.

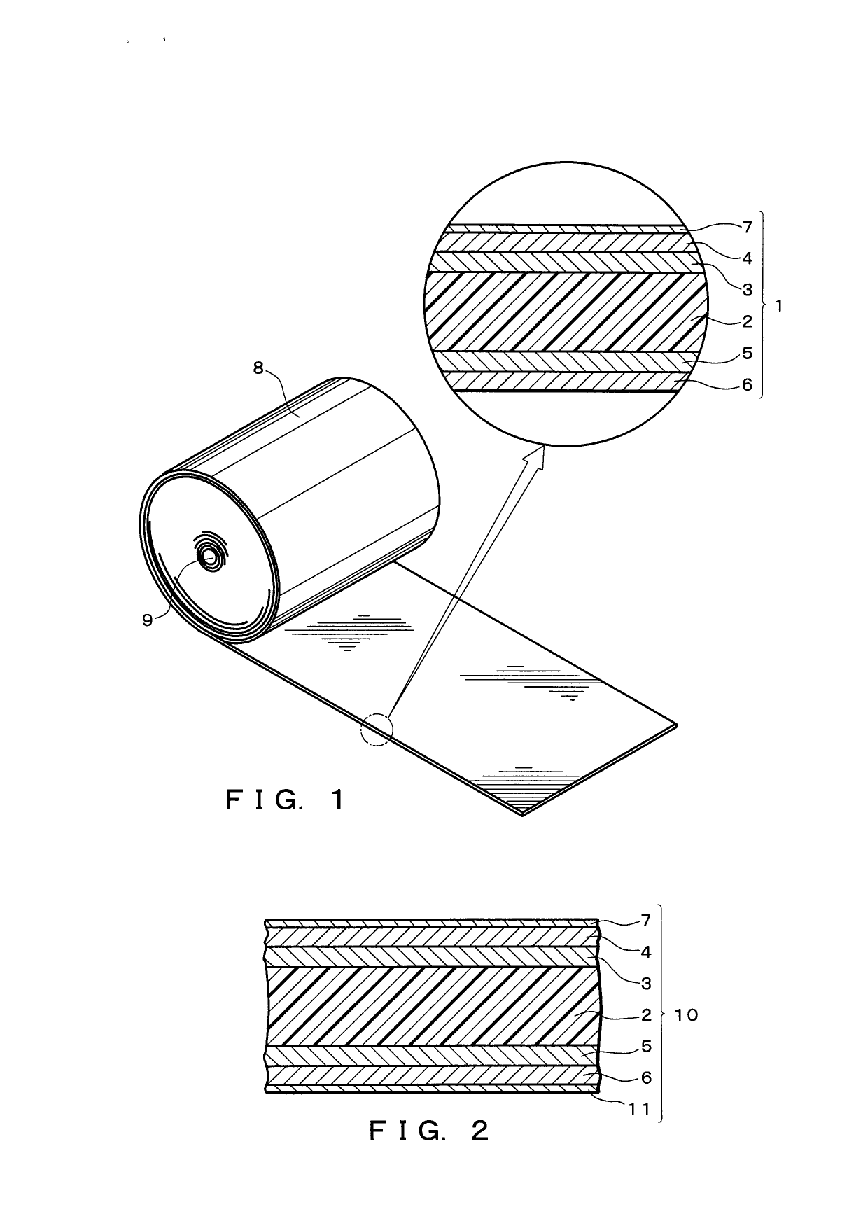

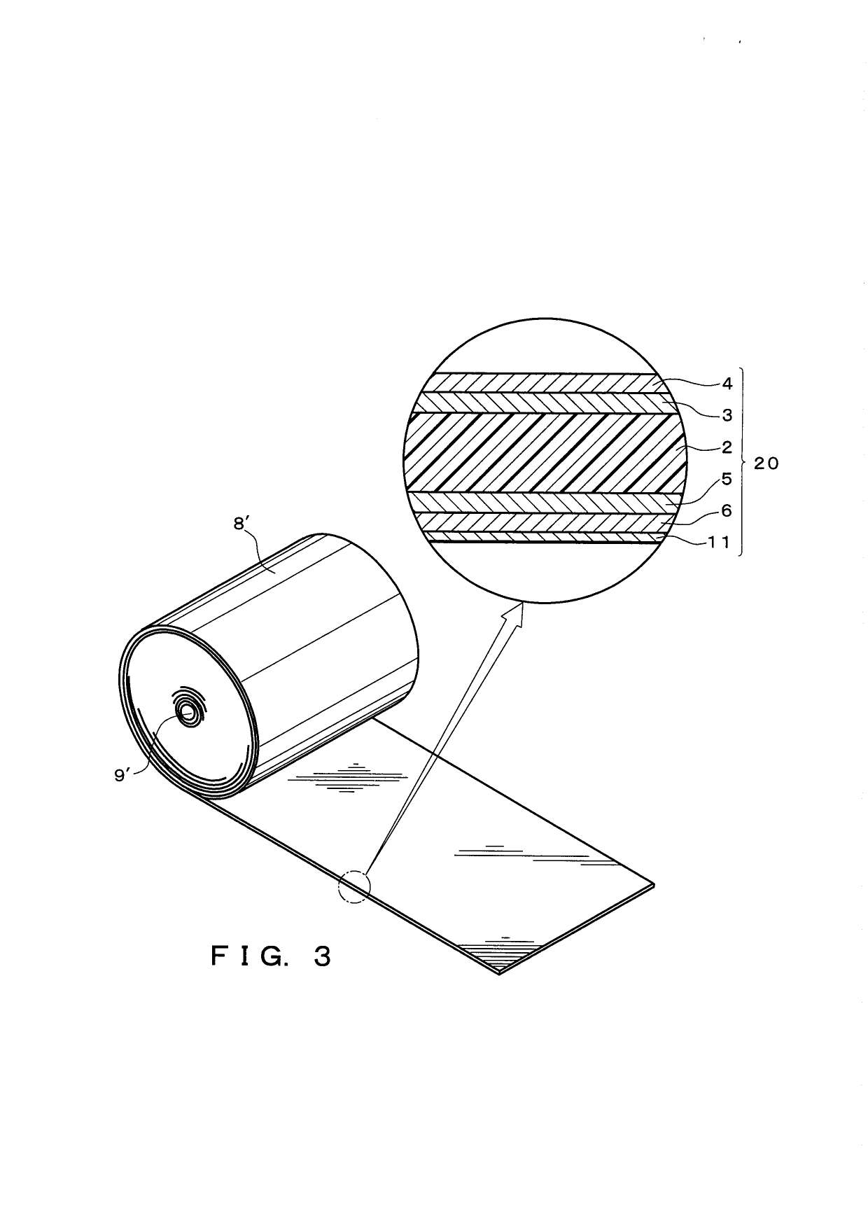

As shown in FIG. 2, as a variant of the conductive film 1, the conductive film 10 may further include, on the copper layer 6, an oxide membrane layer 11 similar to the oxide membrane layer 7 formed on the copper layer 4. The conductive film 1 of the invention includes the oxide membrane layer 7 formed on the copper layer 4 (FIG. 1), but may alternatively include the oxide membrane layer 11 formed on the copper layer 6 (FIG. 3).

Details of each constituent element of the conductive film 1 will now be described below.

(1) Film Base

The film base of the invention supports the transparent conductor layers 3 and 5. The film base has a thickness of, for example, 20 μm to 200 μm. A material forming the film base is preferably polyethylene terephthalate, polycycloolefin or polycarbonate. The film base may include on its surface, an easy adhesion layer that enhances an adhesiveness between the transparent conductor layer and the film base, a refractive index adjustment layer (Index-matching layer) that adjusts a reflectivity of the film base, and a hard coat layer that makes it difficult for the surfaces of the film base to be flawed.

(2) Transparent Conductor Layer

The two transparent conductor layers used in the invention are formed on two side of the film base, respectively. Each of these transparent conductor layers has a thickness of preferably 20 nm to 80 nm. The transparent conductor layer is constituted by a predetermined transparent conductor, and, for example, the transparent conductor is made of a material having a high transmissivity in a visible light range (a largest transmissivity of greater than or equal to 80%) and a surface resistance value per unit area (Ω/□: Ohms per square) of less than or equal to 500Ω/□. The material forming the transparent conductor is preferably indium tin oxide, indium zinc oxide or a composite oxide of indium oxide-zinc oxide.

(3) Copper Layer

The two copper layers used in the invention are formed on the aforementioned two transparent conductor layers, respectively. The aforementioned two copper layers are, for example, when used for a touch panel, used for forming a wiring along an outer peripheral portion of a touch input region by etching a central portion of each copper layer.

Each of the two copper layers has a thickness of preferably 20 nm to 300 nm, and more preferably 25 nm to 250 nm. With such a thickness range, the wiring can be formed with a reduced width.

(4) Oxide Membrane Layer

The oxide membrane layer used in the invention contains copper (I) oxide, and is formed on a side of the transparent conductor layer opposite with respect to the copper layer. The oxide membrane layer is preferably formed to adhere to a surface of the copper layer before oxidization of the copper layer.

The copper (I) oxide is a univalent copper oxide represented by a chemical formula: Cu₂O. The content of copper (I) oxide in the oxide membrane layer is preferably greater than or equal to 50% by weight, and more preferably, greater than or equal to 60%.

The oxide membrane layer may be composed of copper (I) oxide only, or may be composed of a composition including, in addition to copper (I) oxide, copper (non-oxidized copper), copper (II) oxide, copper carbonate and copper hydroxide, or the like.

The oxide membrane layer has a thickness of 1 nm to 15 nm, and preferably, 1.0 nm to 8.0 nm. With the conductive film of the invention, since an oxide membrane layer having a thickness in the aforementioned range is provided, adhesion or bonding can be prevented.

When the oxide membrane layer has a thickness of less than 1 nm, bonding may occur in the conductive film roll, and when the oxide membrane layer has a thickness largely exceeding 15 nm, the productivity of the conductive film may decrease.

Next, a method of manufacturing the conductive film of the invention will be described.

First, a roll of the film base 2 having a length of 500 m to 5,000 m is placed in a sputtering device and unwound at a constant rate. Then, on one of the surfaces of the film base 2, the transparent conductor layer 3, the copper layer 4 and the oxide membrane layer 7 are formed in this order by sputtering. During this, the thickness of the oxide membrane layer 7 is controlled to be 1 to 15 nm. Then, on the other surface of the film base, the transparent conductor layer 5, the copper layer 6, and the oxide membrane layer 11, where necessary, are formed in this order by sputtering. When forming the oxide membrane layer 11 on the copper layer 6, similarly to the oxide membrane layer 7, the thickness of oxide membrane layer 11 is controlled to be 1 nm to 15 nm.

The aforementioned sputtering is a method in which a cation in a plasma generated in a low pressure gas is collided on a target material, which is a negative electrode, and a substance ejected from a surface of the aforementioned target material is deposited on a substrate. In this case, for example, a fired target of indium oxide and tin oxide is used for forming the indium tin oxide layer and an oxygen-free copper target is used for forming the abovementioned copper layer. The oxide membrane layer can be formed by using the copper oxide target or using the oxygen-free copper target and performing sputtering in the presence of an oxygen gas.

In this embodiment, each layer constituting the conductive film is formed with a sputtering method, but it is not limited thereto, and can be formed with a vacuum deposition method.

As has been described above, according to the present embodiment, the oxide membrane layer 7 is formed on a side of the copper layer 4 opposite to the transparent conductor layer 3. Consequently, when the conductive film 1 is wound up in a roll, since the oxide membrane layer 7 is interposed between the copper layer 4 and the copper layer 6, the metallic bonding between the copper layer 4 and the copper layer 6 can be suppressed without having to insert another member such as a slip sheet. Also, with a thickness of the oxide membrane layer 7 containing copper (I) oxide being 1 nm to 15 nm, since the adjacent film surfaces do not bond to each other, the peeling is not produced in the transparent conductor layer 3 and a high quality can be maintained.

In the above description, the conductive film and the conductive film roll of the present embodiment have been described, but the invention is not limited to the embodiment described above, and various alterations and modifications can be made based on a technical concept of the invention.

Hereinafter, examples of the invention will be described.

### EXAMPLES

### Example 1

First, on one side of a film base constituted by a polycycloolefin film (manufactured by Zeon Corporation, product name: “ZEONOR (registered trademark)”) having a length of 1,000 m and a thickness of 100 μm, a first transparent conductor layer constituted by an indium tin oxide layer having a thickness of 20 nm was formed by a sputtering method. Then, on a surface of the first transparent conductor layer, a first copper layer having a thickness of 50 nm and an oxide membrane layer containing 80% by weight of copper(I) oxide and having a thickness of 2.5 nm were sequentially formed by a sputtering method. Then, on the other side of the film base, a second transparent conductor layer constituted by an indium tin oxide layer having a thickness of 30 nm was formed by a sputtering method. Subsequently, on a surface of the second transparent conductor layer, a second copper layer having a thickness of 50 nm was formed by a sputtering method.

A conductive film roll was manufactured by winding up the conductive film thus obtained onto a plastic core.

### Example 2

A conductive film roll was manufactured in a manner similar to Example 1, except that the thickness of the first oxide membrane layer was changed to 1.8 nm by changing the sputtering time.

### Example 3

A conductive film roll was manufactured in a manner similar to Example 1, except that the thickness of the first oxide membrane layer was changed to 5.0 nm by changing the sputtering time.

### Comparative Example 1

A conductive film roll was manufactured in a manner similar to Example 1, except that the thickness of the first oxide membrane layer was changed to 0.5 nm by changing the sputtering time.

### Comparative Example 2

A conductive film roll was manufactured in a manner similar to Example 1, except that the first oxide membrane layer was not formed on the first copper layer.

Next, the aforementioned Examples 1 to 3 and Comparative Examples 1 and 2 were measured and observed in the following manner.

(1) Measurement of Thickness of Oxide Membrane Layer and Content of Copper (I) oxide

Using an X-ray Photoelectron Spectroscopy analyzer device (manufactured by ULVAC-PHI, Inc, product name: “QuanteraSXM”), a thickness of the oxide membrane layer and a percent by weight of copper (I) oxide contained in an oxide membrane layer were measured.

(2) Bonding of Conductive Film

Whether bonding between film surfaces exists or not was determined by unwinding the conductive film from the conductive film roll and observing a roll surface.

The results of evaluations carried out by the aforementioned methods (1) and (2) are shown in Table 1.

TABLE 1

| | THICKNESS OF | | |
|---|---|---|---|
| | OXIDE | | |
| | MEMBRANE | BONDING | |
| | LAYER (nm) | OF ROLL | DETERMINATION |
| EXAMPLE 1 | 2.5 | NO | ◯ (OK) |
| EXAMPLE 2 | 1.8 | NO | ◯ (OK) |
| EXAMPLE 3 | 5 | NO | ◯ (OK) |
| COMPARATIVE | 0.5 | YES | X (NG) |
| EXAMPLE 1 | | | |
| COMPARATIVE | (NO OXIDE | YES | X (NG) |
| EXAMPLE 2 | MEMBRANE | | |
| | LAYER) | | |

As can be seen from Examples 1 to 3 in Table 1, with the thickness of the oxide membrane layer being 1.8 nm to 5.0 nm, no bonding between film surfaces was observed when the conductive film was unwound from the conductive film roll.

On the other hand, as can be seen from Comparative Examples 1 and 2, with the thickness of the oxide membrane layer being 0 nm to 0.5 nm, during the unwinding, a peeling-off sound was produced and numerous flaws were produced on a surface of the first transparent conductor layer or second transparent conductor layer.

Therefore, with the configuration of the conductive film of the invention, it was found that with the thickness of the oxide membrane layer being 1 nm to 15 nm, and more particularly, 1.8 nm to 5.0 nm, the adjacent film surfaces do not bond to each other and a high quality can be maintained.

### INDUSTRIAL APPLICABILITY

The conductive film of the invention is preferably cut into a display size and used in touch sensors of a capacitive type or the like.

What is claimed is:

1. A conductive film comprising:
a film base;
a first transparent conductor layer formed on one side of the film base;
a first copper layer formed on a side of the first transparent conductor layer opposite to the film base;
a second transparent conductor layer formed on another side of the film base;
a second copper layer formed on a side of the second transparent conductor layer opposite to the film base; and
a first oxide membrane layer formed on a side of the first copper layer opposite to the first transparent conductor layer, the first oxide membrane layer containing copper (I) oxide and having a thickness of 1 nm to 15 nm.

2. The conductive film according to claim 1, wherein the first oxide membrane layer has a thickness of 1.0 nm to 8.0 nm.

3. The conductive film according to claim 1, wherein the first oxide membrane layer is made of a composition including greater than or equal to 50% by weight of copper (I) oxide and including copper, copper (II) oxide, copper carbonate and copper hydroxide.

4. The conductive film according to claim 1, wherein the first oxide membrane layer substantially consists of copper (I) oxide.

5. The conductive film according to claim 1, further comprising a second oxide membrane layer formed on a second copper layer, the second oxide membrane layer containing copper (I) oxide and having a thickness of 1 nm to 15 nm.

6. A conductive film roll constituted by the conductive film according to any one of claims 1 to 5 that is wound up in a rolled shape.
